(19) United States
(12) Patent Application Publication
(10) Pub. No.: US 2013/0034630 A1
(43) Pub. Date: Feb. 7, 2013

(54) Reload energy gel for athletes and active adults

(71) Applicant: Bruce Ransom, Las Vegas, NV (US)

(72) Inventor: Bruce Ransom, Las Vegas, NV (US)

(21) Appl. No.: 13/136,618

(22) Filed: Aug. 5, 2011

(51) Int. Cl. A23L 1/304; B65D 85/72

(52) U.S. Cl. 426/74; 426/115

(57) ABSTRACT

An easy-to-carry easy-to-open packet finds use by athletes, mountain climbers and others engaged in physical activity. The packet has a fig paste based energy gel composition comprising glucose and natural fructose sugars which rapidly enter the blood stream. The energy gel optionally comprises ATP, which is released to the blood stream sublingually in the mouth without substantial degradation. The packet has a slit for the insertion of a belt, strap or carabineer. An inserted bonded tube on the packet's exterior edge has one end open and one end closed. The open end is in communication with energy gel within the packet. When the packet is pulled, the inserted bonded tube breaks, creating an open end that is placed between the teeth. Squeezing the packet discharges the gel into the mouth of the user.

### BACKGROUND OF THE INVENTION

1. Field of the Invention

The present invention relates to snack food compositions; and, more particularly, to a compact easy to use packet of energy gel which can be carried in an athlete's or sportsmen's belt or harness and which contains natural constituents comprising body nourishing nutrients and muscle energy releasing compounds.

2. Description of the Prior Art

Many patents and prior art documents relate to quick energy release drinks, bars and the like. The main ingredient of these quick energy release products is a sizable mixture of sugar, caffeine and cocoa that does not provide nutritional benefits to the user. These compositions generally lack nutritional value and merely increase the blood glucose level shortly after consumption. Sugar or glucose enters the bloodstream; but does not become readily available to the muscles for releasing muscle motor activity.

U.S. Pat. No. 6,726,943 to Prosise, et al. discloses nutritionally balanced snack food compositions. These snacks and mixes offer an alternative to appealing but unhealthy snacks. The nutritious snacks are traditional in form, provide a balanced mix of an amino acid source, fat, and carbohydrates and typically have an appeal similar to that of unhealthy snacks of similar form. The snacks and snack mixes are said to resolve the dilemma that consumers are currently faced with, that is, either healthy eating or enjoying what you eat. The nutritional snack is not in the form of an energy gel and is not contained in a single serving packet.

U.S. Pat. No. 7,629,329 to Lee et al. discloses a method for increasing muscle mass and strength through administration of adenosine triphosphate. This method uses compositions that contain an effective amount of Adenosine Triphosphate (“ATP”). This amount is sufficient to increase intracellular and extracellular concentrations of ATP in a mammal to improve anaerobic exercise capacity by increasing muscle size and/or strength. Preferably, a gastric acid secretion inhibitory coating is applied to the effective amount of ATP in a manner that protects the ATP from degradation by gastric juices. ATP compositions may be administered in nutraceutical or functional food dosage forms, including oral and non-oral delivery forms. In addition, the effective amount of ATP maybe combined with amino acids, botanicals, functional foods, herbals, nucleotides, nutraceuticals, nutrients, pharmaceuticals, proteins, and/or vitamins in an effort to enhance the targeted activity of the composition. In spite of the coating that protects the ATP from being destroyed by the gastric juices, the ATP levels are not increased for at least about 60 minutes from the time at which the ATP containing composition is consumed as indicated in the figures. The composition does not provide sustained or increased muscle activity immediately after the consumption of the ATP containing composition, but rather kicks in approximately one hour later.

U.S. Pat. No. 7,825,084 to Harris, et al. discloses methods and compositions for increasing the anaerobic working capacity in tissues. The compositions comprise beta-alanylhistidine peptides and beta-alanines, and methods are provided for administering these peptides and amino acids. The compositions and methods cause an increase in the blood plasma concentrations of beta-alanine and/or creatine. The beta-alanine and the glycine, insulin mimic, or insulin-action modifier to the tissue effectively increase the beta-alanylhistidine dipeptide synthesis in the tissue, thereby increasing the anaerobic working capacity in the tissue. The composition does not contain natural ingredients.

U.S. Pat. No. 7,897,169 to Ueda, et al. discloses ubiquinol-enriched fat-containing foods. The process for producing an ubiquinol-enriched oil/fat-containing food product for human ingestion comprises dissolving ubiquinol in oil/fat under heating first followed by cooling to obtain a homogeneous solution with a melting point of not lower than 20° C., the cooling action solidifying the homogenous composition. The solidified composition is kneaded to form oil-in-water emulsion. The composition formed is not a gel or paste-like substance and is not contained in ready to use individually packed pouches. The composition is oil based, not water based, and does not have other nutrients than ubiquinol.

US Patent Application 20110123653 to McKever et al. discloses compositions and methods for optimizing exercise recovery. The method decreases post-exercise recovery time in a subject using compositions that contain one or more polymethoxylated flavones (PMFs). The composition is an orange peel extract. Post-exercise recovery time is the time required for a subject's post-exercise oxygen consumption VO₂ level to return to a pre-exercise VO₂ level. PMF composition is selected from the group consisting of 5,6,7,3′,4′-pentamethoxyflavone(sinensetin); 5,6,7,8,3′,4′-hexamethoxyflavone(nobeletin); 5,6,7,8,4′-pentamethoxyflavone(tangeretin); 5-hydroxy-6,7,8,3′,4′-pentamethoxyflavone(auranetin); 5-hydroxy-7,8,3′,4′-methoxyflavone; 5,7-dihydroxy-6,8,3′,4′-tetramethoxyflavone; 5,7,8,3′,4′-pentamethoxyflavone; 5,7,8,4′-tetramethoxyflavone; 3,5,6,7,8,3′,4′-heptamethoxyflavone; 5-hydroxy-3,6,7,8,3′,4′-hexamethoxyflavone; 5-hydroxy-6,7,8,4′-tetramethoxyflavone; 5,6,7,4′-tetramethoxyflavone; 7-hydroxy-3,5,6,8,3′,4′-hexamethoxyflavone; and 7-hydroxy-3,5,6,3′,4′-pentamethoxyflavone. This composition merely reduces recovery time and does not increase muscle energy output during exercise.

A number of patents disclose tearable packets. They are discussed next.

U.S. Pat. No. 6,062,468 to Tausanovitch discloses a serving container for food and condiment. The serving container for an elongated food product and a condiment has a conduit formed by a sidewall having an upper sidewall region, which forms an open top, and a lower sidewall region. A condiment container is aligned with and affixed to the lower sidewall region, and has a container rim with leading and rim trailing edges. The condiment container is sealed by a sealing sheet, which peelably engages the container rim with leading and sheet trailing edges. These edges respectively engage the leading and rim trailing edges. A tab attached to the sheet leading edge extends over the sealing sheet and is superimposed over the sheet trailing edge. The tab is maintained in close proximity to the rim trailing edge such that, when the tab is pulled, the pull on the sealing sheet is substantially parallel to the container rim, allowing the sealing sheet to be removed without dislodging a food product contained within the conduit. The tab may be so maintained by a slot in the sidewall through which the tab passes. This container does not contain a single use energy gel and is not attached to a belt of a user.

U.S. Pat. No. 6,935,783 to Carter discloses a single-use container. This single-use container has front and back panels positioned in face-to-face relationship and joined with a sealed region around three edges to define a pouch. The fourth edge is unsealed to form a first opening in the pouch. A pressure sensitive strip on the front and back sides adjacent the opening of the pouch seals the opening when the front and back sides are pressed closed. A tear line is formed at an opposing end of the pouch to enable opening of the opposing end of the pouch. The container may include a tool pouch defined on four sides by the sealed region and containing a spreading tool. The tool pouch is intersected by the tear line, such that, when the container is torn along the line, the tool is released from the tool pouch. The single use container is not indicated to contain an energy gel.

U.S. Pat. No. 7,922,045 to Ianna, et al. discloses condiment packets. This condiment packet is configured to be supported on a surface in a free-standing and upright position. The condiment packet is easily opened and manipulated with one hand. The body of the condiment packet is pyramidal or conical shape and a generally flat base. The condiment packet may include a resilient band disposed on the condiment packet that flexes when the condiment packet is squeezed and springs back when pressure is released. Also, the condiment packet may be provided with a closure comprising a frangible bubble disposed in the opening of the condiment packet. The bubble can be ruptured by squeezing between the thumb and forefingers to open the condiment packet. This condiment packet is placed on a flat horizontal surface and is not looped into a belt or harness of a user. The condiment packet does not contain an energy gel designed to provide sustained energy to the user during exercise.

Internet publication http://www.clifbar.com/food/products shot gel/discloses cliff shot gel contained in a packet. The gel is indicated to be energizing chocolate that will not melt in your pocket. It is contained by a litter leash package that is said to be 90% organic. The nutrition facts indicate that the gel has 110 calories with 1.5 grams of total fat. It has a saturated fat content of 1.0 gram and is indicated to contain no trans-fats. The gel has 60 mg of sodium, 80 mg of potassium. It also has 22 grams of carbohydrates which include 12 grams of sugars and zero grams of protein. The carbohydrates and sugars come from organic maltodextrin, organic evaporated cane juice and organic unsweetened chocolate. The fat essentially comes from chocolate as indicated by the compositions of gels of other flavors. Other ingredients constitute potassium citrate, sea salt, water and natural flavor. The gel is indicated to have 1 gram of dietary fiber. Since fat contains 9 calories per gram, the fat content of the gel provides 1.5×9 or 13.5 calories. The gel has 22 grams of carbohydrates that provide 4 calories per gram or a total of 88 calories. The total calorie content of the gel product is thus 13.5 plus 88 or 100.5, which is less than the indicated 110 calories. This gel composition is mainly a carbohydrate or sugar rich product with no protein, and does not meet the energy needs of an athlete. The new formula is indicated to have three levels of caffeine, which is a stimulant. The package appears to be sealed with a slit opening. When the top of the package is removed, it remains attached to the package housing. In combination, the package components cooperate to produce a “litter leash” that prevents any one component from becoming detached. The web page does not indicate how the packet is opened or how the gel is discharged into the mouth of the user.

There remains a need in the art for easily carried easy to open packets for athletes, hikers, mountain climbers and the like that contain high-energy natural compositions that provide sustained release of sugar to the blood stream and have active ingredients for supporting and enhancing muscle motor activity.

### SUMMARY OF THE INVENTION

The present invention provides easy to carry energy gel packets that are carried by the belt, strap or carabineer of an athlete, hiker, mountain climber or the like. The packets are especially adapted so that the belt, strap or carabineer is readily inserted through a slit in the packet. The slit has a thin outward section, which preferably comprises a tube, one end of which is in communication with the energy gel contained within the packet while the other end of the tube is sealed. The energy gel contained within the packet is easily and reliably discharged into the mouth of the user merely by first pulling the packet from the belt, strap or carabineer and squeezing the packet when the open end of the tube is inserted into the mouth of the user.

The energy gel is predominantly a fig paste or pulp composition that contains a proper amount of electrolyte salts and carbohydrates, protein, and minerals, as well as essentially fatty acids. The fig paste composition is optionally made from a mixture of fig paste with fig concentrate, using a ratio of fig concentrate to fig paste in the range of 0:100 to 100:0. The electrolyte salts of the energy gel contain a balanced proportion of sodium and potassium chloride, for replenishing the lost electrolytes of the athlete during exercise. The sugar content of the fig paste is essentially glucose and fructose derived from a fruit or flower source. The fructose from this natural source is d-fructose which is entirely digestible without oxidative stress and free radical formation during digestion. These natural forms of sugars contain certain minerals that enhance the delivery of glucose, nutrients and oxygen to working muscles. They protect cells from oxidative stress help clear out wastes and support heart and respiratory function. The quick energy boost provided by rapid entry of these sugars into the bloodstream is further enhanced by natural ingredients of the fig paste. These natural ingredients work for up to 4 hours after consumption to increase antioxidant levels, thereby promoting a healthy inflammatory response that promotes a more complete recovery after exercise. Commonly used manufactured sugars, such as processed fructose contain a significant quantity of indigestible 1-fructose or maltodextein that result in oxidative stress and free radical formation and do not afford these advantages. On the other hand, the easily digestible fig paste contains natural fructose and glucose and a moderate glycemic index of about 61 which, unlike maltodextein, helps avoid energy crashes later while still providing a rapid energy boost. Other ingredients present in the energy gel include ATP (a non caffeine stimulant), Ecklonia Cava, CoQ₁₀ (ubiquinone or ubiquinol, non-fermented or fermented anti-oxidant) and berry juice concentrate. The ATP in the energy gel composition is rapidly absorbed sublingually, and enters the blood stream without being subjected to the degradation effects of the stomach acid. Advantageously, the presence of ATP significantly improves the ability of muscles to convert glucose to energy. A single serving of a the energy gel has about 30 grams of fig paste, up to 16 grams of Berry juice concentrates, up to 400 mg of Maqui berry extract, up to 25 mg of Ecklonia Cava, up to 50 mg of CoQ₁₀, up to 400 mg of ATP and up to 200 mg of sea salt.

Extracellular ATP is known to activate special ATP receptors in the cells that line the blood vessel walls. This increases the tone of the blood vessels and dilates the blood vessels through ‘vasodilation’. Advantageously, this process does not increase blood pressure or heart rate, while delivering oxygen more efficiently to muscles. The process is documented by Rosenmeier et al., “Circulating ATP—induced vasodilation overrides sympathetic vasoconstrictor activity in human skeletal muscle” J. Phisol. July 1 2004 558 (Pt 1) pags 351-365.

The packet used has a unique construction comprising a sealed package that contains a slit for insertion of a belt or a strap of a biker, athlete, mountain climber or the like. The slit essentially has the sealed packet on the inside, as well as a segment that surrounds the belt. The segment that surrounds the belt is in the form of a hollow tube with one end in communication with to the gel contained within the packet. The other end of the hollow tube is sealed. When the user pulls on the packet from the belt or the strap, it breaks somewhere in the tubular segment, creating an open end. The other end of the tube is directly connected to the gel contained within the packet. The gel does not flow away at this stage since the gel contained therein is stiff and not free flowing like water. The user inserts the broken end of the tube into the mouth and squeezes the packet to discharge the contents of the packet into the user's mouth. The operation of pulling the packet, and squeezing the packet to discharge the energy gel may be carried out with one hand and can be easily carried by a mountain climber hanging on a rope.

Briefly stated, the invention includes an energy gel delivery system, comprising a packet that is easily carried in the belt or strap of an athlete, mountain climber or any active person, the packet having an energy gel that is made predominantly from fig paste in combination with salts comprising sodium and potassium salts in proper ratios that provide balanced hydration for the user. The packet has a slit through which the belt, strap or carabineer may be looped to hang the packet. When the user pulls on the packet, the thin edge of the slit breaks to thereby open one end of a tube segment in communication with the energy gel while the opposite end of the tube segment is permanently sealed. This tearing action exposes the tube, whereupon the user places the tube between the teeth and squeezes the energy gel into the mouth. The entire operation can be carried out using a single hand. The composition of energy gel is based on fig paste—a composition that comprises glucose and natural fructose. These sugars are much more beneficial than the sugars contained by conventional energy drinks or gels, which comprise 1-fructose as the primary ingredient. Glucose enters the blood stream very fast, whereas 1-fructose takes a significantly greater time, owing to the required conversion of 1-fructose to glucose by stomach acids. Optionally, the energy gel may contain ATP. This compound is absorbed by sublingual action in the mouth when the stiff energy gel slurry is squeezed into the mouth. In another aspect of the invention, the energy gel delivery system can comprise a bottle that contains the energy gel composition and is carried by a holder secured to the waste or other body portion of the user.

Significant advantages are realized by practice of the present invention. In a preferred embodiment, the method of the present invention comprises:
1) An energy gel contained by an easy to carry, easy to peel packet appropriately sized for single use;
2) said energy gel comprising fig paste composition composed of a mixture of fig paste with fig concentrate, using a ratio of fig concentrate to fig paste in the range of 0:100 to 100:0;
3) said fig paste composition being blended with sodium and potassium salts, preserving hydration for the user;
4) said energy gel optionally having one or more additional ingredients selected from the group consisting of ATP, Maqui berry extract, Berry juice concentrates, Ecklonia Cava, CoQ₁₀, and vitamins;
5) said packet having a slit for the insertion of a belt, strap or carabineer, the slit being formed by a thin tubular segment, one end of which is in communication with energy gel contained within the packet and the other end being sealed; and
whereby a user can tear the packet, break the thin tube portion, place the open end of the tube between the teeth, and squeeze the packet, to discharge the thick energy gel into the mouth using a single hand.

### BRIEF DESCRIPTION OF THE DRAWING

The invention will be more fully understood and further advantages will become apparent when reference is had to the following detailed description of the preferred embodiments of the invention and the accompanying drawings, in which:

FIG. 1 illustrates the packet showing a carabineer attached to the slit; and

FIG. 2 illustrates the constructional details of the packet.

### DETAILED DESCRIPTION OF THE INVENTION

This invention provides an easy to carry energy gel packet that has a slit for the insertion of a belt or strap of an athlete or hiker, or a carabineer of a mountain climber or the like. The slit has an outerward facing portion that is made from a tube that has one end open and the other end closed. The open end of the tube is in communication with an energy gel sealed within the energy gel packet. When the user pulls an energy gel packet from the belt strap or carabineer, the tube breaks somewhere in the central region. The energy gel does not drain through the now open end of the tube due to its slurry like consistency. To consume the energy gel, the user places the open end of the tube between the teeth and squeezes the packet to discharge the content of the energy gel into the mouth. This entire procedure of pulling the energy gel packet from the belt, strap or carabineer, as well as squeezing the packet can be carried out using a single hand, thereby facilitating consumption of the energy gel while mountain climbing or even hanging on a rope. There is no spillage of the energy gel from the packet due to its slurry like consistency.

The energy gel is composed predominantly of fig paste or pulp composition that is preferably made from a mixture of fig paste with fig concentrate, using a ratio of fig concentrate to fig paste in the range of 0:100 to 100:0. The fig paste composition additionally contains carbohydrates, protein, mineral as well as essentially fatty acids. The composition of fig paste is available at http://www.botanical-online.com/medicinalsfigueraangles.htm. Fig is a flower rather than a fruit. The fig flowers form inside a pear-shaped receptacle which later becomes fruit green when unripe and matures into yellowish green or dark purple. The protein or amino acids include alanine, aspartine, arginine, cystin, glycine, lysine, lipase, methionine and the like. The sugar content of figs includes glucose and fructose. These sugars enter the blood stream rapidly. Figs also contain enzymes including esterase, ficin, and pectin. The vitamin content of figs includes beta-carotene (vitami, ascorbic-acid (vitamin C), niacin (vitamin B). Fatty acid content of figs includes linoleic acid, malic acid, and oleicacid. The mineral content of the fig includes potassium, phosphorous, magnesium, manganese, and calcium. The fig paste is thus a nutritionally substantial base for the slurry of the energy gel. The composition of the fig paste as provided by Valley Fig Growers of California states that 100 grams of the paste has 289 calories with 70 grams of carbohydrates (59 of which is sugars), 2 grams of protein, 0.15 grams of fat, and 4.25 grams of dietary fiber. The fig paste has 15 mg of sodium and 700 mg of potassium.

Preferably, an additional amount of sodium and potassium salt is added to the fig paste composition; this enables the energy gel composition to replenish electrolytes, which are lost during exercise. A single serving of a typical energy gel has about 30 grams of fig paste, up to 16 grams of Berry juice concentrates, up to 400 mg of Maqui berry extract, up to 25 mg of Ecklonia Cava, up to 50 mg of CoQ10, up to 400 mg of ATP and up to 200 mg of sea salt.

It is well known that ATP is damaged when it contacts water or strong acids such as those present in the stomach. However, as detailed by U.S. Pat. No. 7,629,329 to Lee et al. the ATP may be absorbed sublingually, that is, by the tissues of the mouth and the tongue when the thick slurry of energy gel contacts the mouth. This sublingual absorption allows ATP to enter the blood stream rapidly, so that it quickly reaches the muscles where the rapidly absorbed glucose is converted to muscle motor energy. The fig slurry does not have added water which if present would degrade the ATP compound.

Briefly stated, the subject invention includes a packet that is easily carried in the belt or strap of an athlete, a mountain climber or any active person. The packet has an energy gel that is made predominantly from fig paste composition in combination with salts comprising sodium and potassium salts in proper ratios that provide balanced hydration of the user. The packet has a slit through which the belt, strap or carabineer may be looped to attach the packet. When the user pulls a packet, it breaks free along the thin edge of the slit, exposing the open end of a tubular segment, which communicates with energy gel inside the packet. The opposing end of the tube is permanently sealed. This tearing action exposes the open end of the tube. The user places the tube between the teeth and squeezes the energy gel into the mouth. The entire operation can be carried out using a single hand. The composition of the energy gel is based on fig paste that contains glucose and d-fructose, and other natural sugars. On the other hand, conventional energy drinks use processed fructose as the primary ingredient. Processed fructose does not contain only digestible d-fructose, but also includes 1-fructose which is not digestible. See for example U.S. Pat. No. 4,623,721 to Chen. The attempts to digest 1-fructose in manufactured fructose by the body result in free radical formation and oxidative stress on the body. The natural d-fructose and other sugars of the d-type present in fig paste provide energy with minimal oxidative stress. Conventional energy gels use maltodextein, which is also a manufactured sugar with d and 1 stereochemistry. Optionally, the energy gel may contain ATP. This ingredient, which kindles the energy boost realized from consumption of the gel, is absorbed by sublingual action when the stiff slurry of energy gel is squeezed into the mouth.

The energy gel composition consists essentially of a fig paste or pulp to which may optionally be added an adequate quantity of balanced sodium and potassium salts to replenish electrolytes lost during physical activity. Preferably, the energy gel composition further comprises one or more of the following ingredients: ATP (or AP), Maqui berry extract (organic or non organic), Ecklonia Cava, CoQ₁₀ (fermented or non-fermented), sea salt, and berry juice concentrate (organic or non organic). Examples of the composition for a single serving of reload energy gel contained in a packet is shown below:

| | |
|---|---|
| Fig paste (organic or non organic) | 28.349 g |
| Maqui berry extract (organic or non organic) | 100 mg to 400 mg |
| ATP (or AP) | 100 mg to 400 mg |
| Ecklonia Cava | 5 mg to 25 mg |
| CoQ₁₀ (fermented or non-fermented) | 10 mg to 50 mg |
| Sea salt | 5 mg to 200 mg |
| Berry Juice Concentrate (organic or non organic) | 8 g to 16 g |

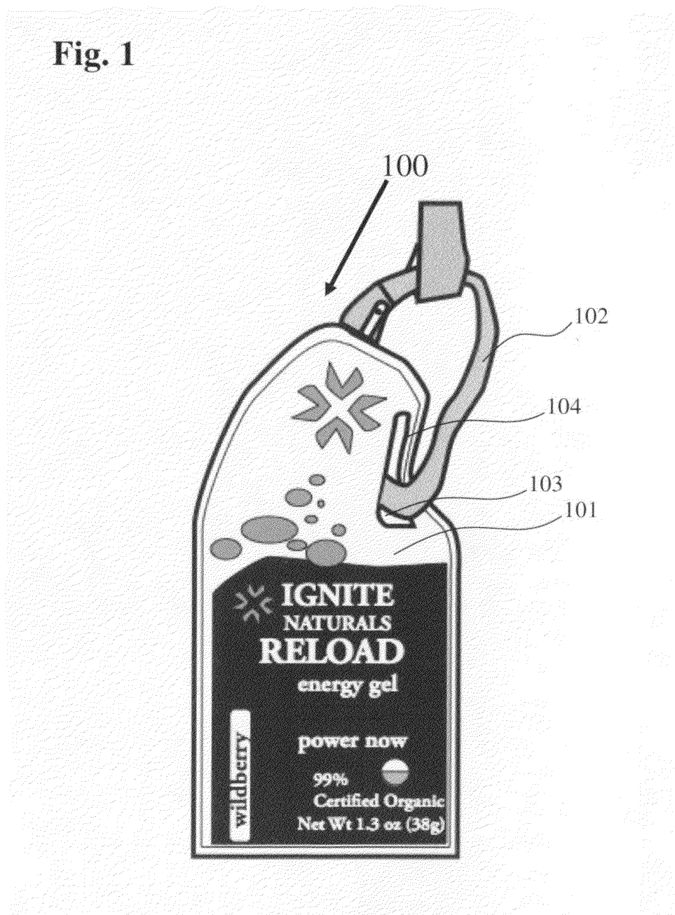

FIG. 1 illustrates at 100 the energy reload gel packet 101 that is attached to a carabineer 102 through a slit 103 in the packet. The slit has an outward facing tube 104. When the user pulls the packet 101, the packet breaks at 104 exposing the open end of the tube. The tube connects to energy gel contained within the packet. This energy gel does not ooze out from the open end due to the stiff consistency thereof. The user places the open end 104 between the teeth and squeezes the packet 101 to discharge the energy gel into the mouth. There may be more than one packet attached to a carabineer and the user pulls the packets one at a time as needed. While this figure shows a carabineer 102, other attachment means, such as a belt or strap may be inserted into the slit 103.

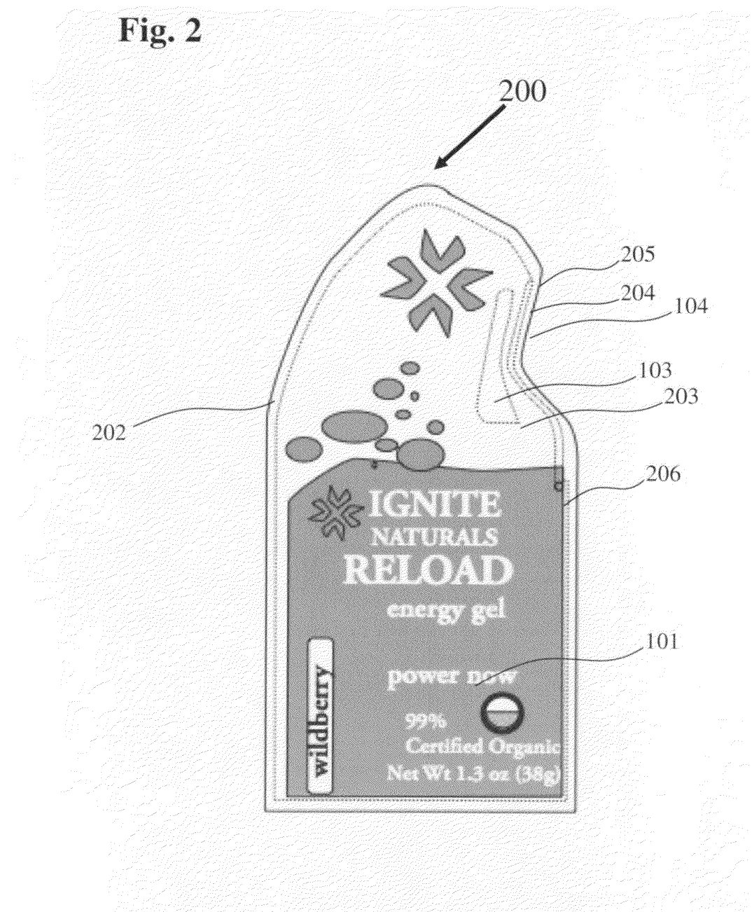

FIG. 2 illustrates at 200 the constructional details of the packet. Similar indicia as shown in FIG. 1 are shown here also. The bonded stitch line is shown at 202. Note that this stitch line completely encircles the energy gel contained within the packet. The slit 103 is also encircled by a similar bonded stitch 203. A tube 204 is provided in the outward segment of the slit 103. This outward segment has a closed end 205 and an open end 206 that is immersed within energy gel contained within the packet 101. When the user pulls the packet from a belt, strap or carabineer to which the packet 101 is attached, a brake occurs at 104 creating an open end for the tube 204. Squeezing the packet 101 causes energy gel contained within the packet 101 to be discharged at the broken free end of the tube 204 which may be placed in the mouth of the user prior to squeezing of the packet.

Having thus described the invention in rather full detail, it will be understood that such detail need not be strictly adhered to, but that additional changes and modifications may suggest themselves to one skilled in the art, all falling within the scope of the invention as defined by the subjoined claims.

What is claimed is:

1) An energy gel delivery system for quick release of energy to a person engaged in physical activity, comprising:
a) a sealed packet containing a stiff slow flowing gel composed of a fig paste or pulp composition;
b) said gel having an adequate quantity of balanced sodium and potassium salts to replenish electrolytes lost during physical activity;
c) said energy gel being contained by a packet that is easily carried and adapted to be opened using a single hand,
whereby, upon consumption, glucose and natural fructose contained by said fig paste or pulp are rapidly released into the blood stream to provide a quick energy boost and increase antioxidant levels, thereby producing a healthy inflammatory response that protects against energy crashes later and promotes a more complete recovery after exercise.

2) The energy gel delivery system as recited by claim 1, wherein said Fig paste composition is composed of a mixture of fig paste and fig concentrate having a ratio of fig concentrate to fig paste in the range of 0:100 to 100:0.

3) The energy gel delivery system as recited by claim 1, wherein said energy gel additionally comprises ATP.

4) The energy gel delivery system as recited by claim 1, wherein said energy gel additionally comprises CoQ₁₀.

5) The energy gel delivery system as recited by claim 1, wherein said energy gel additionally comprises Ecklonia Cava.

6) The energy gel delivery system as recited by claim 1, wherein said energy gel additionally comprises Maqui berry extract.

7) The energy gel delivery system as recited by claim 1, wherein said energy gel additionally comprises Berry Juice Concentrate.

8) The energy gel delivery system as recited by claim 1, wherein said sealed packet is bonded everywhere to thereby enclose said energy gel.

9) The energy gel delivery system as recited by claim 1, wherein said sealed packet has a slit for the insertion of a belt, strap or carabineer, said slit being bonded in its circumference with a bonded inserted tube having an outward facing portion, said tube having an open first end and a closed second end, said first end being in communication with said energy gel.

10) The energy gel system as recited by claim 8, wherein pulling the sealed packet breaks the bonded inserted tube exposing access to energy gel contained in said packet.

11) The energy gel system as recited by claim 8, said energy gel being delivered into the mouth of the user when the open first end of the inserted tube is placed between the teeth.

12) For use in a system for quick release of energy to a person engaged in physical activity, a composition, comprising:
a) a stiff slow flowing gel composed of a fig paste or pulp composition;
b) said gel having an adequate quantity of balanced sodium and potassium salts to replenish electrolytes lost during physical activity;
whereby, upon consumption, glucose and natural fructose contained by said fig paste or pulp are rapidly released into the blood stream to provide a quick energy boost and increase antioxidant levels, thereby producing a healthy inflammatory response that protects against energy crashes later and promotes a more complete recovery after exercise.

13) The system as recited by claim 12, wherein said Fig paste composition is composed of a mixture of fig paste and fig concentrate having a ratio of fig concentrate to fig paste in the range of 0:100 to 100:0.

14) The system as recited by claim 12, wherein said energy gel additionally comprises ATP.

15) The system as recited by claim 12, wherein said energy gel additionally comprises CoQ₁₀.

16) The system as recited by claim 12, wherein said energy gel additionally comprises Ecklonia Cava.

17) The system as recited by claim 12, wherein said energy gel additionally comprises Maqui berry extract.

18) The system as recited by claim 12, wherein said energy gel additionally comprises Berry Juice Concentrate.

19) The system as recited by claim 14, wherein said energy gel additionally comprises CoQ₁₀.

20) The system as recited by claim 19, wherein said energy gel additionally comprises Ecklonia Cava.

21) An energy gel composition, consisting essentially of:
a) a stiff slow flowing gel composed of a fig paste or pulp composition;
b) said gel having an adequate quantity of balanced sodium and potassium salts to replenish electrolytes lost during physical activity;
whereby, upon consumption, glucose and natural fructose contained by said fig paste or pulp are rapidly released into the blood stream to provide a quick energy boost and increase antioxidant levels, thereby producing a healthy inflammatory response that protects against energy crashes later and promotes a more complete recovery after exercise.

22) The energy gel composition as recited by claim 21, wherein said Fig paste composition is composed of a mixture of fig paste and fig concentrate having a ratio of fig concentrate to fig paste in the range of 0:100 to 100:0.

23) The energy gel composition as recited by claim 21, wherein said energy gel additionally comprises ATP.

24) The energy gel composition as recited by claim 21, wherein said energy gel additionally comprises CoQ₁₀.

25) The energy gel composition as recited by claim 21, wherein said energy gel additionally comprises Ecklonia Cava.

26) The energy gel composition as recited by claim 21, wherein said energy gel additionally comprises Maqui berry extract.

27) The energy gel composition as recited by claim 21, wherein said energy gel additionally comprises Berry Juice Concentrate.

28) The energy gel composition as recited by claim 23, wherein said energy gel additionally comprises CoQ₁₀.

29) The system as recited by claim 28, wherein said energy gel additionally comprises Ecklonia Cava.
